(19) United States
(12) Patent Application Publication
(10) Pub. No.: US 2008/0067202 A1
(43) Pub. Date: Mar. 20, 2008

(54) High Visibility Safety Vest With Integrated Hydration Bladder System

(75) Inventors: Lisa Ruth Silva, Fulshear, TX (US); James B. Duke, Houston, TX (US)

Correspondence Address: KING & SPALDING, LLP, 1100 LOUISIANA ST., STE. 4000, ATTN.: IP Docketing, HOUSTON, TX, 77002-5213, US

(73) Assignee: Igloo Products Corp., Katy, TX (US)

(21) Appl. No.: 11/857,651

(22) Filed: Sep. 19, 2007

Related U.S. Application Data
(60) Provisional application No. 60/845,849, filed on Sep. 20, 2006.

(51) Int. Cl. A45F 3/16; A41D 1/04; F21V 7/00

(52) U.S. Cl. 224/148.2; 2/102; 362/108

(57) ABSTRACT

A combination high visibility safety vest and hydration bladder system includes a vest having a pouch along its back side capable or receiving and holding a bladder portion of the hydration bladder system. The pouch includes raised inserts along its exterior to raise portions of the pouch away from the user's back. The vest also includes a background material made of a daytime-visible fluorescent color and nighttime and light reflective material positioned thereon to increase the visibility of the user to others. The vest includes tear-away straps and seams to increase the safety of the user if the vest is entangled. The hydration bladder system includes a bladder that can be filled with fluid in an insulated pouch. The hydration bladder system provides hydration to the user by way of tubing coupled on one end to the bladder and on the other end to a mouthpiece.

### STATEMENT OF RELATED PATENT APPLICATION

This non-provisional patent application claims priority under 35 U.S.C. §119 to U.S. Provisional Patent Application No. 60/845,849, titled High Visibility Safety Vest With Integrated Hydration Bladder System, filed Sep. 20, 2006. This provisional application is hereby fully incorporated herein by reference.

### FIELD OF THE INVENTION

This invention relates generally to the field of personal hydration systems. More particularly, the present invention relates to the field of safety clothing with integrated hydration features.

### BACKGROUND OF THE INVENTION

Medical research has demonstrated the importance of maintaining adequate hydration while engaging in strenuous physical activities, such as bicycling or mountain climbing. However, adequate hydration is also necessary for those who are working. In fact, the Occupational Safety and Health Administration (“OSHA”), as well as other regulatory agencies, recommend that employees consume one quart of fluid per hour to maintain proper hydration levels while performing work activities outdoors or in warm environments.

A study by California Occupational Safety and Health Administration (“Cal OSHA”) found that even when water was available on the worksite, heat stress injuries still occurred because workers did not stop working often enough to consume adequate amounts of fluids. This prompted Cal OSHA to implement a regulation requiring employers to provide ready access to fluids and take measures to ensure their workers consume a minimum of one quart of water per hour. Road construction, building construction, and road or near-road maintenance workers often spend most of their day outside, susceptible not only to the elements and dehydration, but also to the hazards of cars or machinery that they work around. Similar dangers can be found in some internal environments, such as manufacturing or product distribution facilities. Conventional portable hydration systems have been incorporated into some recreational equipment, such as backpacks, and have also been provided as a stand-alone option for workers, who can wear them over their clothing; however neither of these conventional products combine the protection of a safety vest with the convenience of portable hydration for those working and susceptible to the elements, hydration and/or hazardous work environments.

To maintain proper hydration, people who enter into these types of careers either carry water or other fluids with them in a canteen or bottle, from which they drink periodically, or are forced to seek out fluids periodically, either from a water-fountain, water cooler, or break area. To protect themselves from potential work hazards, such as cars, machinery or other co-workers, employees in these and other similar fields of work typically wear day-glow and retroreflective safety vests that attract the eyes of other people and lights of vehicles, and thereby increase the visibility of the employee and reduce the likelihood of harm to the employee. However, if the employee is not carrying hydration with him, the employee must continuously travel back-and-forth from the area they are working in to the location where water or other hydration has been stationed for his use. These continuous trips not only reduce the efficiency of the employee but they also increase the likelihood of injury to the employee, because the employee must often pass through dangerous or high-traffic areas to reach the hydration station.

Therefore there is a need in the art for high visibility safety clothing that is capable of receiving and holding a hydration bladder system that provides the user of the clothing ready access to fluids while being highly visible when working.

### SUMMARY OF THE INVENTION

The combination high visibility safety vest and hydration bladder system provides its user safety while working in hostile environments by increasing the visibility of the user, while also providing the user with easily portable hydration that is accessible during work periods. The combination vest and hydration bladder system includes a safety vest having a hydration pouch along its back side. The hydration pouch can be capable of receiving and holding a hydration bladder therein. The hydration pouch can include raised inserts along its user-facing to raise portions of the hydration pouch away from the back of the user to increase airflow and reduce heat retention along the back of the user. A hydration pouch flap cover can be positioned over the hydration bladder system opening to prevent airborne dust and contaminants from collecting on the bladder fill cap. Above the hydration pouch, a grommet can be included for passing through the tubing, valve, and mouthpiece portions of the hydration bladder system so that the user can access the fluid in the hydration bladder system without having to remove the vest. The pouch flap cover can also include a pocket for storing items needed by the user out in the field or in the facility, such as cell phones, keys and other items.

The safety vest can also include a background material made of a daytime visible fluorescent color and a nighttime light reflective material, such as retroreflective tape, that can be positioned along the exterior of the background material to increase the visibility of the user to others. The vest can also include tear-away straps and seams so that the vest will break away from the user in the event that the vest is grabbed or entangled, thereby increasing the safety of the user. The safety vest can also include expandable chest straps that allow for a snug fit during normal use but also allow the straps to expand when the user is reaching for items or exerting additional force that cause's the user's chest area to expand.

The hydration bladder system can include a bladder that can be filled with fluid and placed in the hydration pouch through an opening under the pouch flap. The inside of the hydration pouch can be insulated to reduce temperature change of the fluids in the bladder contained therein. The hydration tubing can be insulated to reduce loss of fluid temperature while the fluid passes from the bladder to the user's mouth, or when occupying the tube awaiting use. The hydration bladder system can provide hydration to the user by way of tubing coupled on one end to an outlet port of the bladder and on the other end to a mouthpiece. Herein, when the terms “attached” and “coupled” are used to describe the relationship of two features, the terms are not to be construed in a narrow sense but should be interpreted broadly to include, but not be limited to, attached, coupled, affixed to, releasably coupled, slidably coupled, permanently coupled, and integral with. In another embodiment, the tubing can be coupled to a manually adjustable valve, which can then be coupled to a mouthpiece which may be suction or bite activated to release and obtain fluids from the bladder.

For one aspect of the present invention the combination safety vest and hydration bladder system can include a safety garment. The safety garment can include a front section and a rear section that form a torso encircling garment. For example, the garment can be a vest, a short-sleeved shirt, a long-sleeved shirt, overalls, or a jumpsuit. The invention can also include a hydration system. The hydration system can include a fluid reservoir that is made to hold fluid. The hydration system can also include a flexible tube assembly that is coupled to and designed to receive fluid from the fluid reservoir.

For another aspect of the present invention, the combination safety vest and hydration bladder system can include a garment that is substantially in the shape of a vest that can be worn by a user. The garment can include both background material and retroreflective material. The background material can include a mesh-type material. When combined on the exterior surface area of the garment, the background material can be exposed on a greater surface area of the garment than the retroreflective material. The garment can also include a hydration system that is positioned adjacent the garment. The hydration system can include a bladder that is designed to hold fluid therein. The bladder can include an exit port for the dispensing of fluid from the bladder. The hydration system can also include a flexible tube assembly that can include a first end and a second end. The first end of the tube assembly can be in fluid communication with the exit port of the bladder such that fluid can flow from the bladder out of the exit port and into the tube assembly. The hydration system can also include a flow-restricting device that includes a body and a flow restricting mechanism. The body of the flow-restricting device can include an input mount, an output mount and a fluid passageway between the input and output mount. The input mount can be in fluid communication with the second end of the flexible tube assembly. The flow restricting mechanism can be selectively positioned between an open and a closed position to allow or prevent fluid to flow from the input mount, through the fluid passageway and out of the output mount. The hydration system can also include a mouthpiece, which can be in fluid communication with the output mount of the flow-restricting device.

For still another aspect of the present invention, the combination safety vest and hydration bladder system can include a safety garment having a front section and a rear section that form a torso encircling garment. The garment can also include a pair of shoulder straps that can be attached at one end to the rear section of the garment. The garment can also include a hydration system that can include a fluid reservoir, a flexible tube assembly, and a flow restricting device. The flexible tube assembly can be in fluid communication with the fluid reservoir and designed to receive fluid from the reservoir. The flow restricting device can also be in fluid communication with the flexible tube assembly.

### BRIEF DESCRIPTION OF THE DRAWINGS

For a more complete understanding of the exemplary embodiments of the present invention and the advantages thereof, reference is now made to the following description in conjunction with the accompanying drawings in which:

FIGS. 1A-1D illustrate front and rear views of a combination high visibility safety vest and hydration bladder system according to one exemplary embodiment of the present invention;

FIG. 2 illustrates an interior view of the combination high visibility safety vest and hydration bladder system that focuses on the user-facing area between the hydration bladder system and the person wearing the vest according to the exemplary embodiment of FIGS. 1A-1D;

FIG. 3 illustrates a detailed rear view of the top portion of the combination high visibility safety vest and hydration bladder system according to the exemplary embodiment of FIGS. 1A-1D;

FIGS. 4A and 4B illustrate detailed views of the chest connection feature and expansion strap of the high visibility safety vest and hydration bladder system according to the exemplary embodiment of FIGS. 1A-1D;

FIG. 5 illustrates a detailed view of the chest connection breakaway feature of the high visibility safety vest and hydration bladder system according to the exemplary embodiment of FIGS. 1A-1D;

FIG. 6 illustrates a detailed view of the shoulder seam breakaway feature of the high visibility safety vest and hydration bladder system according to the exemplary embodiment of FIGS. 1A-1D;

FIG. 7 illustrates a detailed view of the hydration pouch cover and pocket of the high visibility safety vest and hydration bladder system according to the exemplary embodiment of FIGS. 1A-1D;

FIG. 8 illustrates a detailed view of an exemplary bladder system for the high visibility safety vest and hydration bladder system according to the exemplary embodiment of FIGS. 1A-1D;

FIGS. 9 and 9A illustrate a detailed view of an exemplary tubing assembly and mouthpiece for a hydration bladder system according to the exemplary embodiment of FIG. 8;

FIG. 10 illustrates a perspective rear view of a high visibility safety vest and hydration bladder system having a high content of breathable mesh background material according to an alternative exemplary embodiment of the present invention;

FIG. 11 illustrates a view of an exemplary hydration pack according to another alternative exemplary embodiment of the present invention;

FIG. 12 illustrates a view of a combination high visibility safety vest and hydration pack according to another alternative embodiment of the present invention;

FIGS. 13 and 14 illustrate front and rear views of a high visibility safety vest and hydration bladder system according to another alternative exemplary embodiment of the present invention; and

FIGS. 15-30 illustrate additional views of the high visibility safety vest and hydration bladder system according to the embodiments disclosed in FIGS. 1-14.

### DETAILED DESCRIPTION OF THE EXEMPLARY EMBODIMENTS

Exemplary embodiments of the present invention will now be described in detail with reference to the included figures. The exemplary embodiments are described in reference to how they might be implemented. In the interest of clarity, not all features of an actual implementation are described in this specification. Those of ordinary skill in the art will appreciate that, in the development of an actual embodiment, several implementation-specific decisions must be made to achieve the inventors' specific goals, such as compliance with system-related and business-related constraints that can vary from one implementation to another. Moreover, it will be appreciated that such a development effort might be complex and time-consuming, but would nevertheless be a routine undertaking for those of ordinary skill in the art having benefit of this disclosure. Further aspects and advantages of the various figures of the invention will become apparent from consideration of the following description and review of the figures.

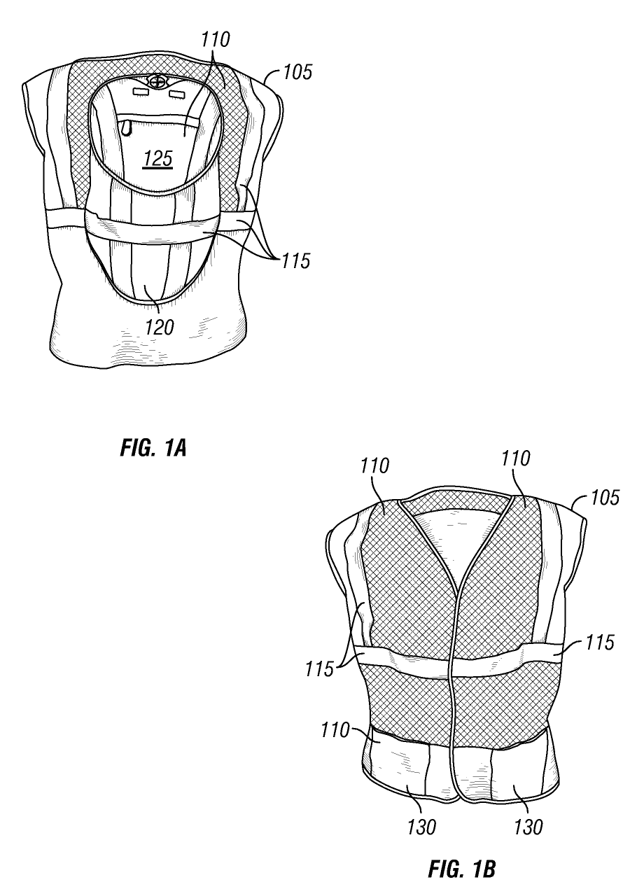

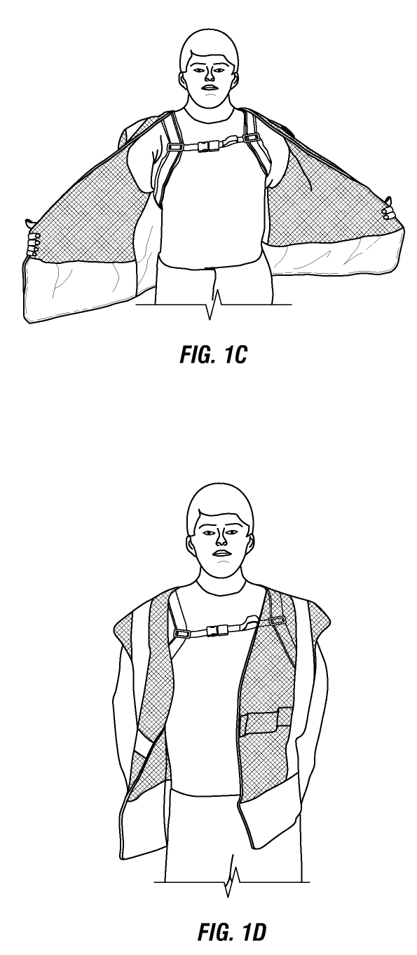

Referring now to FIGS. 1A and 1B, front and rear views of the combination high visibility safety vest and hydration bladder system (hereinafter “vest”) 105 are described according to one exemplary embodiment of the present invention. The exemplary vest 105 can include a background material 110 and a retroreflective material 115. In one exemplary embodiment, the background material 110 has a greater exposed surface area than the retroreflective material 115. In this exemplary embodiment, the vest 105 satisfies American National Standards Institute (“ANSI”) 107 Class I and II standards for high visibility safety.

In one exemplary embodiment, the vest 105 resembles a vest-shaped garment; however, the invention contemplates the vest 105 having the following alternate designs: a short-sleeved shirt, a long-sleeved shirt, overalls, and a jumpsuit, and while described herein as a vest 105, each of these alternate designs are capable of incorporating the features discussed herein. In these exemplary and alternative embodiments, the background material 110 may be made completely of a mesh material, with or without mesh material swatches included, or in one exemplary embodiment, the background material may be made with a combination of woven material with mesh swatches inserted along different sections of the background material 110. In one exemplary embodiment, the background material 110 is made of nylon. The background material 110 may be provided in any color approved to attract the attention of others including, in one exemplary embodiment, fluorescent or Day-Glo colors, typically yellow or orange.

The vest 105 also includes retroreflective material 115 attached by known attachment means along different portions of the background material 110. In one exemplary embodiment, the retroreflective material 115 includes retroreflective tape that is positioned along intersecting substantially horizontal and vertical lines across the background material 110, as shown in FIGS. 1A and 1B. The vest 105 also includes a hydration pouch 120 incorporated into and along the back side of the vest 105. Those of ordinary skill in the art will recognize that the hydration pouch 120 may be positioned in other areas of the vest 105 including, but not limited to, the front of the vest 105, either side of the vest 105, along the waist area of the vest 105 in proportion to the user or covering more than one of the noted areas by extending along or wrapping around the vest 105 from one area to another. The hydration pouch 120 is accessible from the exterior of the back side of the vest 105, as shown in FIG. 1A, however in an alternative embodiment, the hydration pouch 120 can be accessible from the interior of the back side of the vest 105 or from the side of the vest 105. The hydration pouch 120 is capable of receiving, by slidable insertion, a bladder portion and at least part of a hose portion of a hydration bladder system (discussed hereinafter).

The hydration pouch 120 may also include insulation material (Not Shown) along the inside of the hydration pouch 120 to keep the contents of the hydration bladder cold or hot for a longer period of time. In one exemplary embodiment, a combination of polyurethane and polyethylene foam insulation is used inside the interior of the hydration pouch 120; however, those of ordinary skill in the art will recognize that many other forms of insulating material may be used, including polystyrene, air, etc. The insulation is then surrounded by a sheet of pliable or nonpliable material (Not Shown) to form the interior of the hydration pouch 120. In the exemplary embodiment of FIG. 1A, the bladder portion of the hydration bladder system can be slidably inserted into the hydration pouch 120 by lifting the pouch cover flap 125.

The vest 105 may also include one or more pockets 130 along the front side of the vest 105. Each pocket 130 may be opened at the top or provided with a closure means, such as a button, snap, or zipper, to ensure the retention of the contents of the pocket 130 while working. The pocket 130 is generally of a size capable of receiving and holding within its boundaries objects such as keys, a cell-phone, or other objects of like size. In one exemplary embodiment, the pocket 130 includes a zipper and zipper pull for opening and closing the pocket 130.

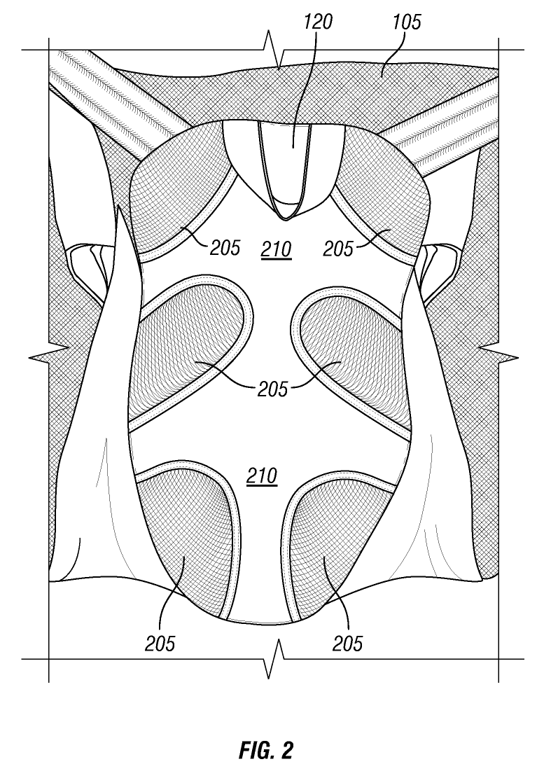

FIG. 2 provides an interior view of the combination vest and hydration bladder system according to one exemplary embodiment of the present invention. Now referring to FIG. 2, the side of the hydration pouch 120 in the vest 105 that rests upon the user's back, also known as the user-facing, may also include one or more inserts 205. The inserts 205 raise a portion of the hydration pouch 120 that does not include inserts 205 away from the back of the user. In one exemplary embodiment, each insert 205 is made of a padding material and covered by layers of a mesh material, such as nylon, on the side of the padding facing the user's back. The use of a mesh material to cover the padding increases the breathability of the fabric and padding and reduces the heat retention along the back of the user. However, those of ordinary skill in the art will recognize that solid woven material or other materials may be used to cover the padding and materials other than padding may be used to raise portions of the hydration pouch 120 away from the user's back. In an alternative embodiment, risers or other material (Not Shown) can be positioned along and coupled to the exterior of the side of the hydration pouch 120 that rests upon the user's back to accomplish the same objective of raising a portion of the hydration pouch that does not have risers thereon away from the back of the user. Risers can include, but are not limited to, mesh covered padding material coupled to the exterior of the side of the hydration pouch 120 that rests upon the user's back.

The placement of the inserts 205 can create channels 210, which are portions of the hydration pouch 120 that are raised away from the user's back. The channels 210 allow for increased airflow along the user's back and can limit the heat transfer between the hydration pouch 120 and the user. While the exemplary embodiment of FIG. 2 presents six raised inserts 205 and six channels 210, those of ordinary skill in the art will recognize that an infinite number of combinations of insert size, shape, and placement may be used within the scope of this invention.

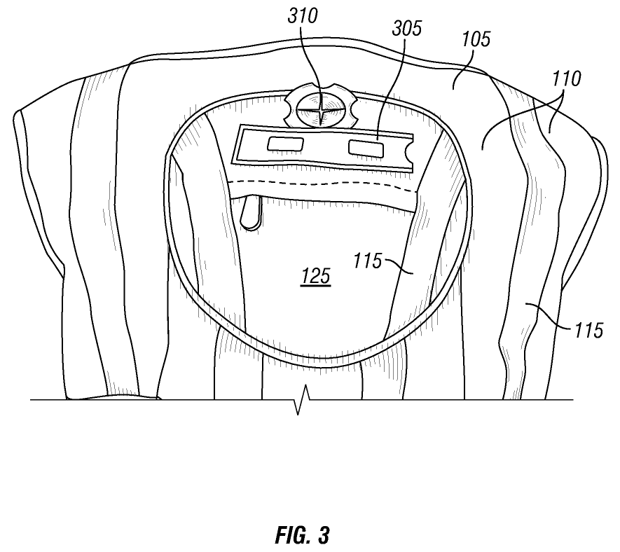

FIG. 3 provides a detailed view of the pouch cover flap 125 according to one exemplary embodiment of the present invention. Now referring to FIG. 3, the pouch cover flap 125 may include background material 110 and retroreflective material 115, similar to the other portions of the vest 105. The pouch cover flap 125 may also include a name sleeve 305. The name sleeve 305 allows a user or company to designate the wearer of the vest 105 to limit sanitary issues related to shared use of the hydration bladder system included within the hydration pouch 120. In one exemplary embodiment, the name sleeve 305 includes a panel with three sides enclosed by a clear plastic or plastic-like material so that a name card (Not Shown) may be slidably inserted into the sleeve 305 along one side. In an alternative embodiment, the name sleeve 305 may include a panel of Velcro that is capable of receiving a similarly sized panel having the name of the user on one side and a corresponding piece of Velcro on the other. Both of these options allow for the easy removal and reattachment or insertion of different names once the hydration bladder system has been cleaned or, removed and the new user's hydration bladder system inserted.

The pouch cover flap 125 also includes a grommet 310, however those of ordinary skill in the art will recognize that the grommet 310 could be positioned along the top of the hydration pouch 120 above the pouch cover flap 125. The grommet 310 allows the tubing, valve and mouthpiece portions of the hydration bladder system to pass through and reach around towards the front side of the vest 105.

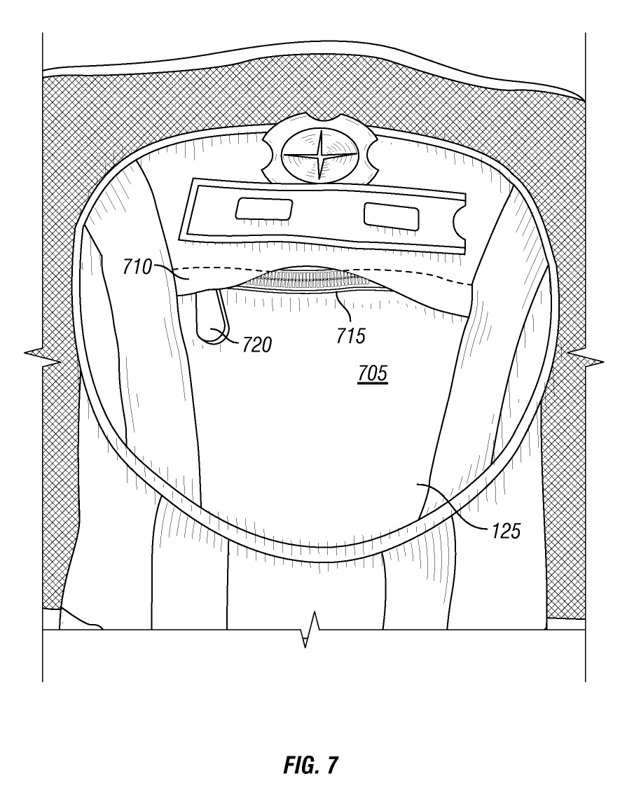

Now referring to FIGS. 3 and 7, the pouch cover flap 125 may also include a pocket 705 positioned along the exterior of the pouch cover flap 125. The interior of the pocket 705 may be made of a mesh or woven material and is capable of holding items including, but not limited to, keys, wallets, writing utensils, and the like. The pocket 705 may also include a closure device 715. In one exemplary embodiment, the closure device 715 is a zipper; however, those of ordinary skill in the art will recognize that other closure devices including, but not limited to, Velcro, buttons, or snaps could be used within the scope of this invention. In the exemplary embodiment, the zipper 715 includes a zipper pull 720 for opening and closing the zipper 715. The pocket 705 can also include a pocket closure flap 710 attached on one or more sides to the pouch cover flap 125 and extending over all or a portion of the closure device 715.

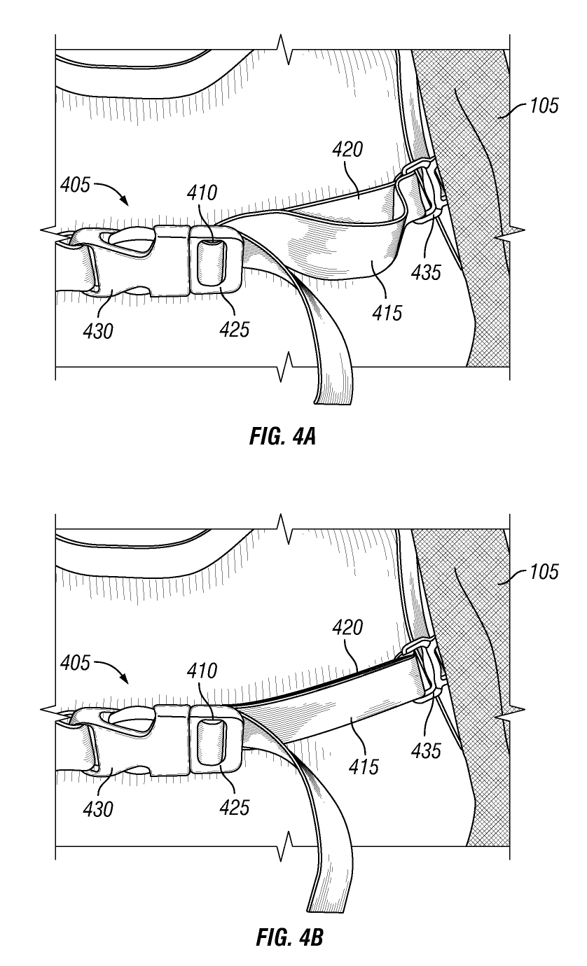

FIGS. 4A and 4B provide two views of the chest connection feature of the vest 105 according to one exemplary embodiment of the present invention. Now referring to FIGS. 4A and 4B, the vest 105 can include a fastener 405 having a male 425 and female 430 portion. The male 425 and female 430 portions of the fastener 405 can be coupled or attached to one another and have their opposing ends attached to straps 415. Each strap 415 is attached at one end to a portion of the fastener 405 and at the other end to a grommet (Not Shown) or second fastener 435, which is attached to the shoulder straps or vest 105. In one exemplary embodiment, the fastener 405 is a buckle that can be manually engaged and disengaged; however, other fastening devices known to those of ordinary skill in the art may be used without diverting from the scope of this invention.

The fastener 405 may also include an adjustment mechanism 410 that allows the user to extend or reduce the length of the strap for individual sizing and comfort. In addition, the strap 415 can include an elasticized insert 420. The elasticized insert 420 allows for temporary expansion, or lengthening, of the distance between the fastener 405 and the second fastener 435 while the user is reaching or undergoing strenuous activity. Those of ordinary skill in the art will recognize that while the elasticized insert 420 is only shown on one side of the chest strap, it is well within the scope of this invention to incorporate the elasticized insert 420 on either or both sides of the chest strap or on any other strap which may be included with the vest 105.

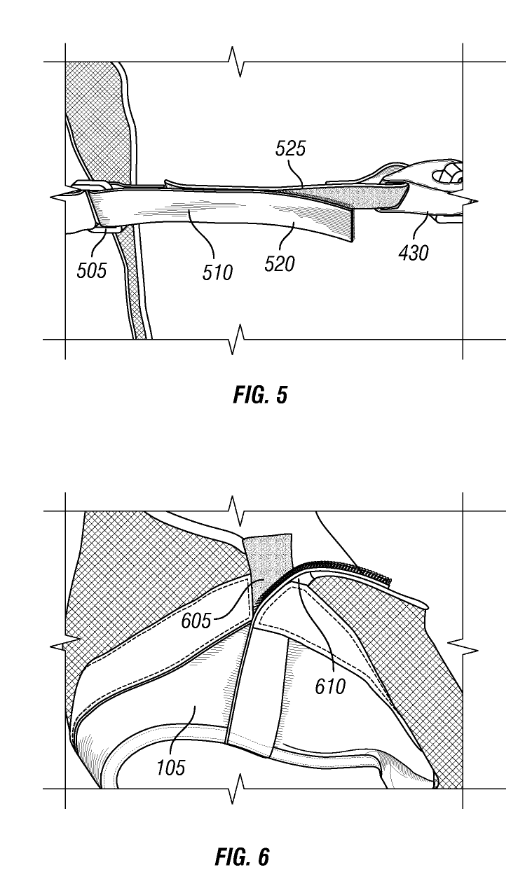

FIGS. 5 and 6 provide views of a chest strap breakaway and a shoulder seam breakaway according to one exemplary embodiment of the present invention. Now referring to FIGS. 5 and 6, the chest strap breakaway 510 may include two individual pieces of breakaway material that are capable of being attached to one another. In one exemplary embodiment, the breakaway material is Velcro; however, those of ordinary skill in the art will recognize that other materials and breakaway devices may be incorporated into the strapping system and are within the scope of this invention. A first piece of breakaway material 520 is attached at one end to a third fastener 505. A second piece of breakaway material 525 is attached at one end to the female fastener 430. The two pieces of breakaway material 520, 525 may be brought together and coupled in order to create a continuous strap from the female fastener 430 to the third fastener 505. The breakaway material provides added safety in the event that the vest 105 becomes entangled or caught and puts the user in peril, by allowing the breakaway strap to more easily separate at the first 520 and the second 525 pieces of breakaway material.

In FIG. 6, a view of the breakaway seam along the shoulder area of the vest 105 is illustrated. The shoulder breakaway seam includes a first breakaway material 605 attached to a first part of the seam while a second breakaway material 610 is attached to the corresponding portion of the shoulder seam for the vest 105. In one exemplary embodiment, the breakaway material is Velcro; however, those of ordinary skill in the art will recognize that other materials and breakaway devices may be incorporated into the shoulder seams of the vest 105 and are within the scope of this invention. In addition, while not shown, breakaway seams may be incorporated into other seams of the vest 105 depending on the needs of the user and the danger in the environment. In operation, as shown in FIG. 6, the first breakaway material 605 may be attached to the second breakaway material 610 to form the shoulder seam. In the event that the vest 105 becomes entangled and potentially imperils the user, the shoulder seam will break apart, or separate, and allow the user to more easily remove the vest 105.

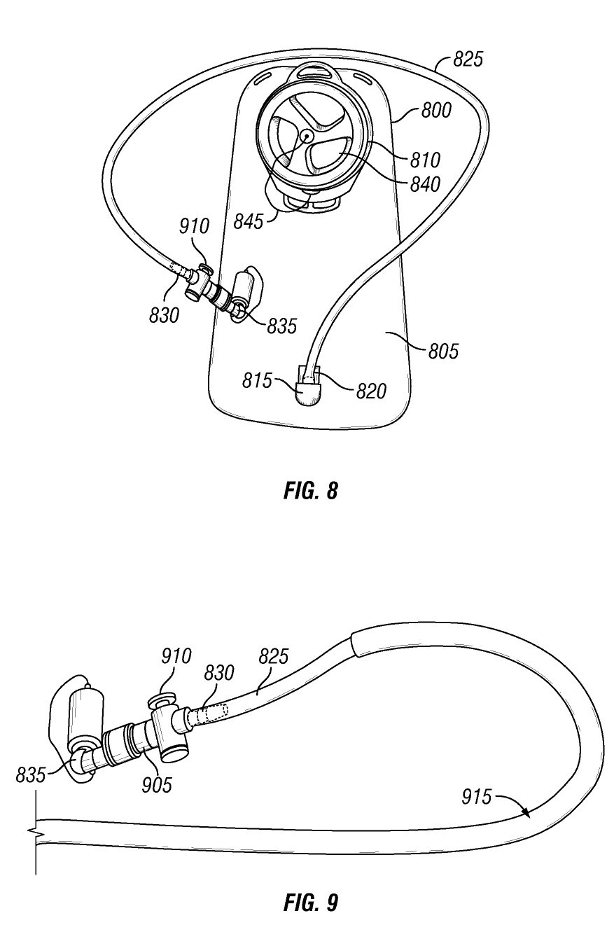

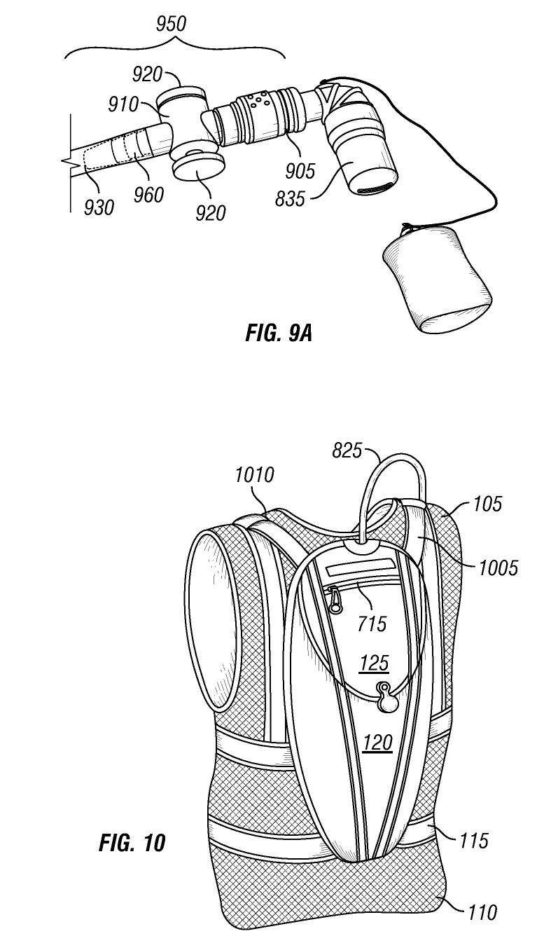

FIGS. 8 and 9 provide detailed views of a hydration bladder system according to one exemplary embodiment of the present invention. Now referring to FIGS. 8 and 9, the hydration bladder system is shown generally at 800 in FIG. 8. The hydration bladder system 800 includes a fluid reservoir, or bladder, 805 for storing fluid (such as water, sports drinks, etc.). The bladder 805 is preferably flexible and may vary in shape and size depending on the volume of fluid to be carried by the user and the shape of the hydration pouch 120 or other storage container into which the bladder 805 is stored when carried by the user. The bladder 805 includes an input port, such as a sealable filler spout 810 with a bladder fill cap 840, which may be opened to empty, fill, or clean the bladder 805. In one exemplary embodiment, the bladder fill cap 840 can include one or more recesses, or alternatively raised sections, along its outward facing surface to improve the ability to grasp the cap 840 when it is being tightened or loosened. The bladder fill cap 840 can also include a tether line 845 attaching the cap 840 to the bladder system 800 to reduce the chance of loss or dropping of the cap 840 during filling, cleaning, and/or drying of the bladder 805. The bladder 805 also includes an exit port or output port, 815 onto which one end 820 of a flexible tube, or tube assembly, 825 is mounted. It is also possible that the input port 810 and the exit port 815 could be designed as a single port for both filling and removing fluid from the bladder 805. As used herein, the term “tube assembly” may refer to a single length of tubing that defines a fluid conduit for drink fluid drawn from the reservoir 805, as well as to a plurality of interconnected lengths of tubing. The end 820 may be removably attached to the exit port 815, or it may be integrally formed or permanently mounted thereupon.

The tube assembly 825 is of sufficient length to extend from the bladder 805 to the user's mouth when the vest 105 is worn by the user. The distal end 830 of tube assembly 825 may be adapted to provide fluid to a user's mouth. Typically, a mouthpiece 835 is coupled with the distal end 830 of the tube assembly 825, such that the tube assembly 825 is in fluid communication with the mouthpiece 835. The mouthpiece 835 may be removable from the tube assembly 825 or alternatively may be integrated with the tube assembly 825. For example, the mouthpiece 835 may simply be the distal end 830 of the tube assembly 825 distal the output port 815, the output mount 905 of the subsequently described flow-restricting valve, or structure that is removably or permanently attached to the distal end 830. An example of a mouthpiece 835 is a bite-actuated, or mouth-actuated mouthpiece 835 that is selectively deformed from a closed position, in which fluid is prevented from being dispensed from the mouthpiece 835, to a dispensing (or open) position, in which the user may draw fluid from the bladder 805 through the tube 825 and the mouthpiece 835, when the user compresses or provides suction on the mouthpiece 835 with the user's teeth or lips. Bite-actuated mouthpieces 835 are often biased or otherwise configured to automatically return to the closed position when a user is not exerting force upon the mouthpiece 835.

The exemplary hydration bladder system 800 further includes a flow-restricting device, such as a flow-restricting valve assembly 910, positioned downstream from the output port 815 and upstream from the mouthpiece 835 or the distal end 830 of the drinking tube assembly 825. The valve assembly 910 may be positioned at any point downstream from the reservoir 805. For example, in FIG. 9, the valve assembly 910 is shown positioned toward the distal end 830 of the tube assembly 825. In such a configuration, the mouthpiece 835 may be permanently or removably coupled to the valve assembly 910. Alternatively, the valve assembly 910 may be positioned between two lengths of tubing which form the tube assembly 825. In such an embodiment, the mouthpiece 835 may be coupled to the tube assembly 825 or the distal the valve assembly 910, or the distal end 830 of the tube assembly may form the mouthpiece 835.

In one exemplary embodiment, the valve assembly 910, as shown in FIG. 9A, includes a valve that may be selectively adjusted by a user to prevent fluid in the reservoir 805 from flowing through the valve assembly 910 to the mouthpiece 835 and to permit fluid in the reservoir 805 to flow from the reservoir 805 through the valve assembly 910 to the mouthpiece 835. For example, the valve may be selectively positionable by a user between an open configuration in which fluid may flow through the valve, and a closed configuration, in which fluid from the reservoir 805 cannot flow through the valve. More particularly, the valve assembly 910 can include a flow-restricting mechanism, for example a pushbutton lever 920, that can be push-activated across the fluid flow area in such a way that when the pushbutton lever 920 is depressed in one direction fluid may flow from the tube assembly 825 to the mouthpiece 835 and when the pushbutton lever 920 is depressed in the opposite direction fluid flow is restricted and the fluid cannot pass through the valve assembly 910 to the mouthpiece 835. In one exemplary embodiment, the pushbutton lever 920 may include a relatively flat cap affixed or made integral as a part of each opposing end of the pushbutton lever 920. In this exemplary embodiment, a first cap may be presented in a first color representing to the user that depressing the first cap will allow fluid to flow, while the second cap may be presented in a second color representing to the user that depressing the second cap will prevent fluid from flowing. In one exemplary embodiment, the first color is green and the second color is red. While the exemplary embodiment describes the valve to include the pushbutton lever 920, those of ordinary skill in the art recognize that many other valve mechanisms could be used in place of or in conjunction with the pushbutton lever 920, such as gate valves, rotating valves, globe valves, butterfly valves, and ball valves, and are within the scope of this invention.

It is within the scope of the invention that the valve assembly 910 may also be adapted to provide one or more flow configurations between the above-described closed position and a fully open position. For example, the valve may be positionable in one or more intermediate flow configurations in which only a portion of the maximum flow available in the open configuration may pass through the valve. By providing such intermediate positions, a user may be able to regulate the amount of fluid flow accessible through the mouthpiece 835.

Preferably, the valve is a manually actuated valve, which means that a user must apply a force to the valve to configure the valve between its positions. Similarly, the valve may be constructed to remain in a user-selected position within the valve's defined range of positions even after the user-applied force is removed. For example, once the user configures the valve to its open position, the valve may remain in that position until the user applies sufficient force to configure the valve to a different position. A benefit of such a construction is that the user does not have to apply constant pressure or force on the valve to retain the valve in a particular user-selected position. However, it is within the scope of the invention that the valve may include a biasing assembly or mechanism, such as one or more springs, deflectable members, or elastomeric members, that automatically return the valve to a particular position, such as the closed position, upon removal of user applied force. A benefit of such a configuration is that the user does not have to remember to return the valve to the resting, or unactuated, position.

The valve assembly 910 may be permanently attached to the tube assembly 825 and/or the mouthpiece 835, such as being integrally formed therewith or permanently attached thereto, such as with an adhesive, weld, or other permanent fastening mechanism. By “permanently attached,” it is meant that the attached structures are not readily removable from each other without destroying at least a portion of one of the attached structures. Alternatively, the valve assembly 910 may be a modular valve assembly 910 that is releasably attached to the tube assembly 825 and/or the mouthpiece 835. By “releasably attached,” it is meant that the device may be repeatedly removed from its attachment to the corresponding structure and then reattached thereto. A benefit of a modular valve assembly 910 is that the valve assembly 910 may be removed from the hydration bladder system 800 for cleaning, replacement, upgrades, etc.

The valve assembly 910 can include an input mount 930 and an output mount 905. The internal channel within the valve assembly 910 between the input mount 930 and the output mount 905 can be considered the fluid passageway 950 though which fluid flows in the valve assembly 910. In one exemplary embodiment, the input mount 930 is releasably attached to the tube assembly 825 through the use of a barbed attachment 960 to allow fluid to pass from the tube assembly 825 into the valve assembly 910. In another exemplary embodiment, the output mount 905 is releasably attached to the mouthpiece 835 to allow fluid to pass from the valve assembly 910 to the mouthpiece 835.

The tubing assembly 825 may also include insulation 915 surrounding all or a portion of the tubing assembly 825 in order to maintain the temperature of the fluid in the tubing assembly 825. In one exemplary embodiment, the insulation is neoprene or similar material surrounding the exterior of the tubing assembly 825. The mouthpiece 835 may also include a magnetic mouthpiece holder (Not Shown) positioned along one side of or near the mouthpiece assembly 835. The magnetic mouthpiece holder may be affixed and removable from a mouthpiece holder (Not Shown) having magnetic properties on the vest 105. Those of ordinary skill in the art will recognize that other methods for holding the mouthpiece 835 in place on the vest 105 while not in use by the user may also be used including, but not limited to, Velcro or snaps.

FIGS. 10 and 12 provide views of exemplary embodiments of vests 105 that are designed to meet European Norm (“EN”) 471 Class 2 standards for high visibility safety. FIG. 10 provides a perspective view of an exemplary high visibility safety vest and hydration bladder system according to an alternative embodiment of the present invention. Now referring to FIG. 10, the vest 105 may be designed in such a way that the hydration bladder system may be marketed separately from the high visibility vest 105 and provided as a retrofit kit that would enable a user to modify their vest 105 to include the hydration bladder system, including the hydration pouch 120, affixed to the back of vest 105. As shown in FIG. 10, the hydration pouch 120 can be attached to the vest 105 by way of straps 1005, 1010 affixed at one end to each shoulder area of the vest 105 and affixed on the other end substantially near the top of the hydration pouch 120. The hydration pouch 120 may also be affixed to the vest 105 near the middle or lower portion of the hydration pouch 120 by known attachment means including, but not limited to, sewing, straps, snaps, or Velcro. In another alternative embodiment, the straps 1005, 1010 can be replaced by other means of attachment known to those of ordinary skill in the art including, but not limited to, buttons, snaps, sewing, and Velcro.

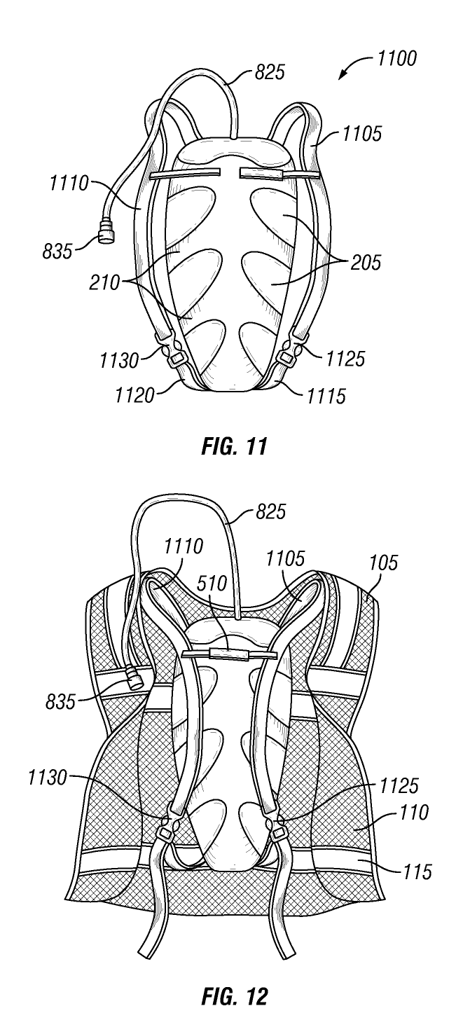

FIG. 11 provides a view of an exemplary hydration pack that can be incorporated into or combined with an exemplary high visibility safety vest 105 according to another alternative embodiment of the present invention. Now referring to FIG. 11 the hydration pack 1100 includes the hydration pouch 120, inserts 205, channels 210, tubing 825, mouthpiece 835, and bladder 800 (Not Shown), as well as other features of the exemplary hydration pack 1100. In addition, the alternative hydration pack 1100 includes shoulder straps 1105, 1110 that each can be attached to bottom straps 1115 and 1120 respectively by attachment mechanisms, such as fasteners 1125, 1130. The makeup and variety of fasteners 1125, 1130 is comparable to that described in FIGS. 4A and 4B. The straps 1105, 1110, 1115, 1120 or the fasteners 1125, 1130 may also include adjustment means (Not Shown), such as an adjustment mechanism, for adjusting the length of the straps 1105, 1110, 1115, 1120 for the comfort of each individual user. The strap and fastener system is designed such that a user can insert each arm between the strap and fastener system and the hydration pouch 120 so that the hydration pouch 120 rests on the user's back and the shoulder straps 1105, 1110 extend from near the top of the hydration pouch 120, over a shoulder of the user, and down the user's torso, where it is attached to the bottom straps 1115, 1120 by way of the fasteners 1125, 1130. In this exemplary embodiment, the hydration pack 1100 is supported by the straps 1105, 1110, 1115, 1120, which are independent of the vest 105. Thus, while the straps 1105, 1110, 1115, 1120 may be fastened around the user, the front side of the vest 105 may be fastened or unfastened based on the preference of the user.

In an alternative embodiment, the fasteners 1125, 1130 are removed and the strapping system includes an adjustment means, such as an adjustment mechanism, for adjusting the length of the strapping system while maintaining the straps for each side of the user as a single cohesive piece. The hydration pack 1100 may be inserted into the interior, back side of a high visibility safety vest 105 as described hereinabove. The hydration pack 1100 may be attached to the interior of the vest 105 by means of attachment known to those of ordinary skill in the art including, but not limited to, Velcro, buttons, snaps, and sewing. The combination hydration pack 1100 and vest 105 may also include a chest strap breakaway 510 as described in FIG. 5 hereinabove. The chest strap breakaway 510 may be attached at one end to one shoulder strap 1105 and attached at the other end to the other shoulder strap 1110.

While shown and described in greater detail in FIGS. 11 and 12, those of ordinary skill in the art will recognize that the internal strapping system for the hydration pack 1100 along the inside of the vest 105, described in greater detail with regards to the straps 1105, 1110, 1115, 1120 and fasteners 1125, 1130, may also be incorporated into the exemplary embodiments of FIGS. 1A-D, 2, 3, 4A, 4B, 5-7, 10, and 20-30 and are considered within the scope of this invention. One advantage of the internal strapping system being independent from the front side of the vest 105 of FIGS. 1A and 1B is that it allows the user to wear the vest 105 with the front side open, or unfastened, as shown in FIGS. 1C and 1D, while still providing support for the hydration pack 1100. In addition, the straps 1105, 1110, 1115, 1120 of the exemplary internal strapping system shown in FIG. 11, but configurable to the other exemplary embodiments as described above, may also be made of, incorporate, or include retroreflective material to further increase the visibility of the user to others.

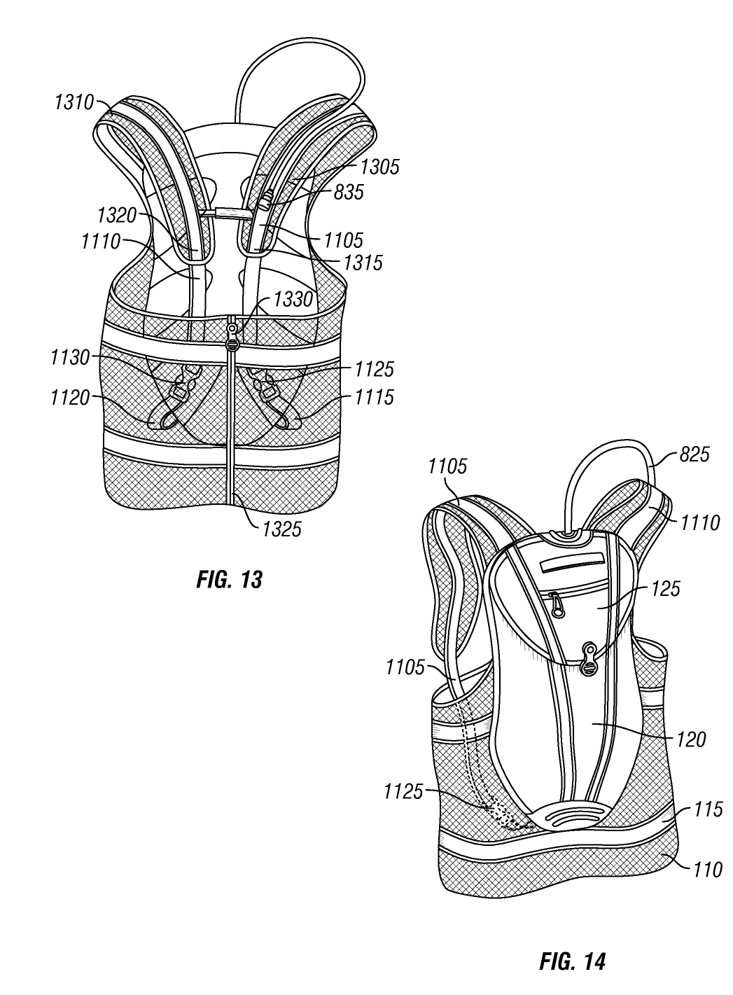

FIGS. 13 and 14 provide two views of an exemplary combination high visibility safety vest and hydration bladder system according to still another alternative embodiment of the present invention. Now referring to FIGS. 13 and 14, the hydration bladder system is similar to that described in FIG. 11, having a similar shoulder strap 1105, 1110, bottom strap 1115, 1120, and fastener 1125, 1130 attachment system. In this alternative embodiment, the hydration bladder system may be positioned either along the interior or exterior side of the back of the vest 105 depending on the needs of the user or employer.

The vest 105 includes one or more shoulder straps 1305, 1310 that extend from the back side of the vest 105, over the shoulder and down the torso of the user. The vest 105, may also include a closure device 1325 positioned along the front side of the vest 105 and extending vertically from the bottom to the top of the front side of the vest 105. In one exemplary embodiment, the closure device 1325 is a zipper; however, those of ordinary skill in the art will recognize that other closure devices including, but not limited to, Velcro, buttons, or snaps could be used within the scope of this invention. In the alternative embodiment, the zipper 1325 includes a zipper pull 1330 for opening and closing the zipper 1325.

When wearing the vest 105 and hydration bladder system, the user can insert each shoulder strap 1305, 1310, though a cut-out or sleeve 1315, 1320 in the vest shoulder straps 1305, 1310. If the hydration bladder system is placed inside the back side of the vest 105, each shoulder strap 1105, 1110, can pass through the sleeves 1315, 1320 from the inside of its respective vest shoulder strap 1305, 1310 to the outside of its respective vest shoulder strap 1305, 1310. The hydration bladder system may further be attached to the back side of the vest 105 by known attachment means including, but not limited to, Velcro.

On the other hand, if the hydration bladder system is positioned along the exterior of the back side of the vest 105, each shoulder strap 1105, 1110, will pass through the sleeves 1315, 1320 from the outside of its respective vest shoulder strap 1305, 1310 to the inside of its respective vest shoulder strap 1305, 1310. The hydration bladder system may further be attached to the exterior of the vest 105 by known attachment means including, but not limited to, Velcro.

In yet another alternative embodiment, the shoulder straps 1105, 1110 may be inserted into a first set of sleeves (Not Shown) positioned near the top of the hydration bladder system on each shoulder strap 1305, 1310 of the vest 105. The first set of sleeves may be continuous, running the length of each vest shoulder strap 1305, 1310 and ending at the sleeves 1315, 1320, or non-continuous, substantially similar to the description of sleeves 1315, 1320. In the embodiment in which the first set of sleeves is continuous, each shoulder strap 1105, 1110 may be inserted at the entry point of the first set of sleeves and continue along a channel (Not Shown) designed to encompass the shoulder straps 1105, 1110, along the length of each vest shoulder strap 1305, 1310 and exit from the channel at sleeves 1315, 1320. This channel may be positioned along the interior or exterior of the shoulder straps 1305, 1310 for the vest 105.

In the embodiment in which the first set of sleeves is non-continuous, each shoulder strap 1105, 1110 may be passed through one of the first set of sleeves from the interior of the vest shoulder strap 1305, 1310 to the exterior of the vest shoulder strap 1305, 1310, or vice-versa depending on whether the hydration bladder system is positioned along the interior or exterior of the back side of the vest 105. Each shoulder strap 1105, 1110 may then be passed through one of the sleeves 1315, 1320 from the exterior of the vest shoulder strap 1305, 1310 to the interior of the vest shoulder strap 1305, 1310, or vice-versa. Each shoulder strap 1105, 1110 may then be coupled to its respective bottom strap 1115, 1120 by its respective fastener 1125, 1130.

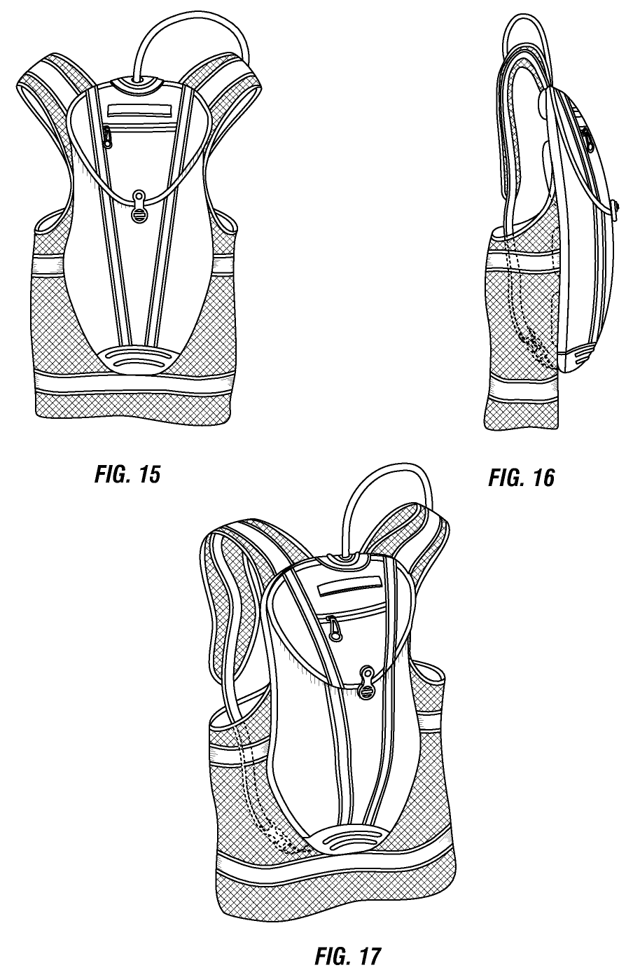

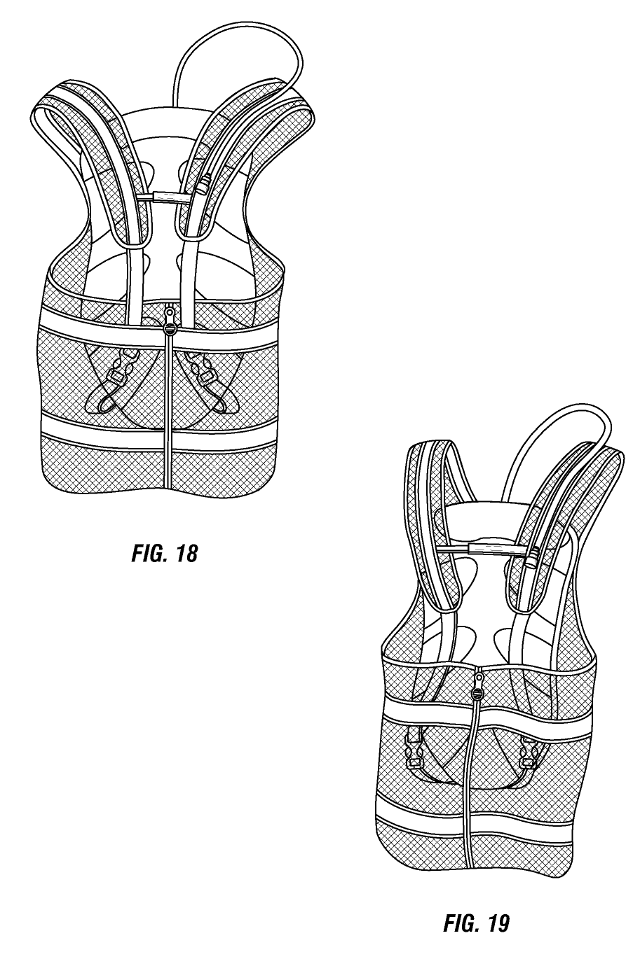

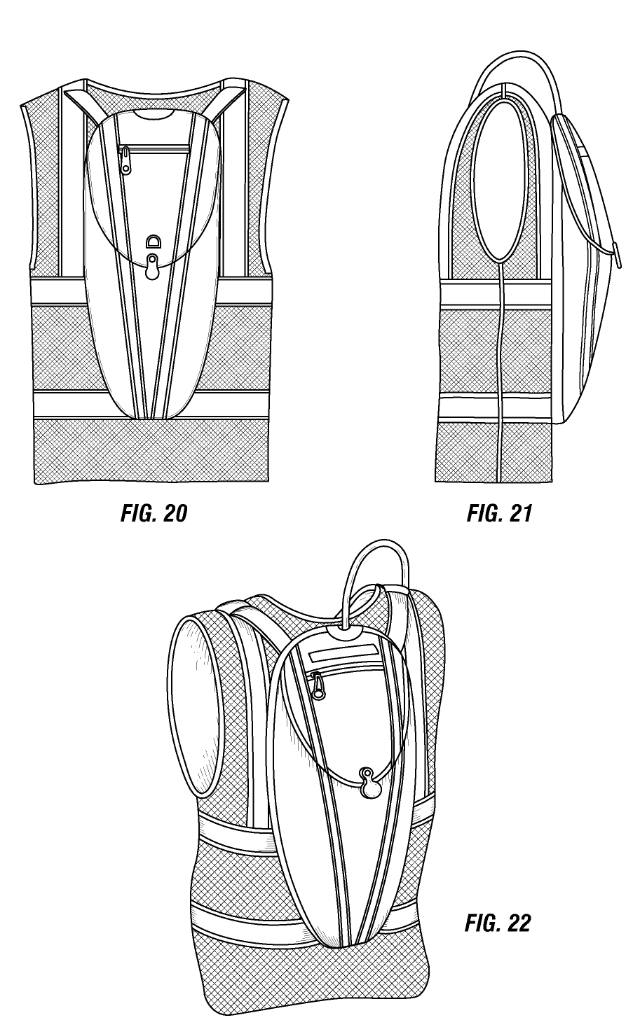

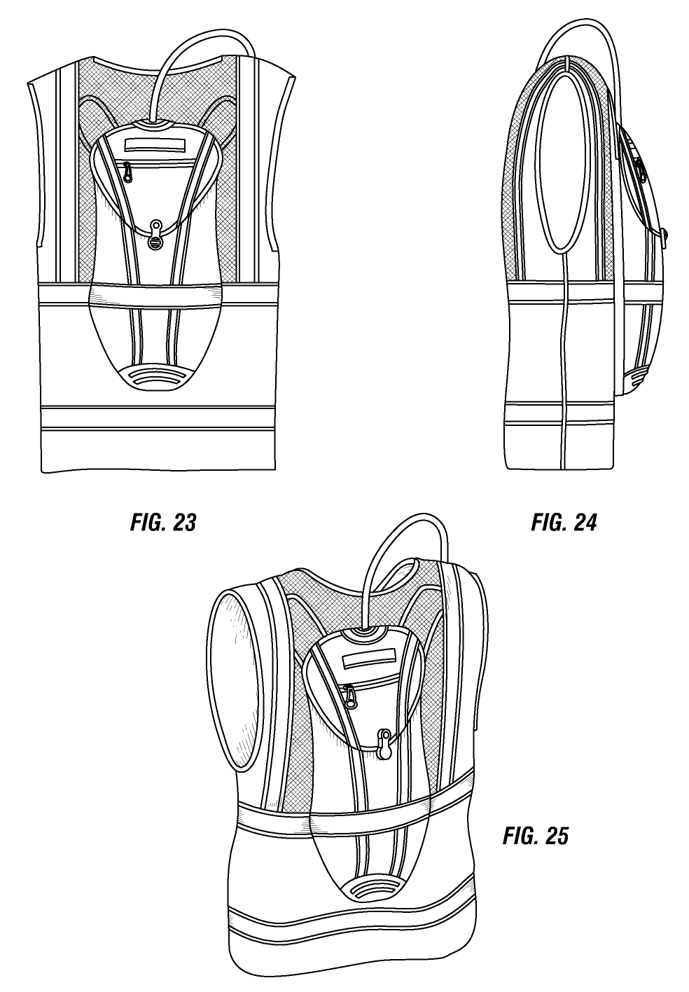

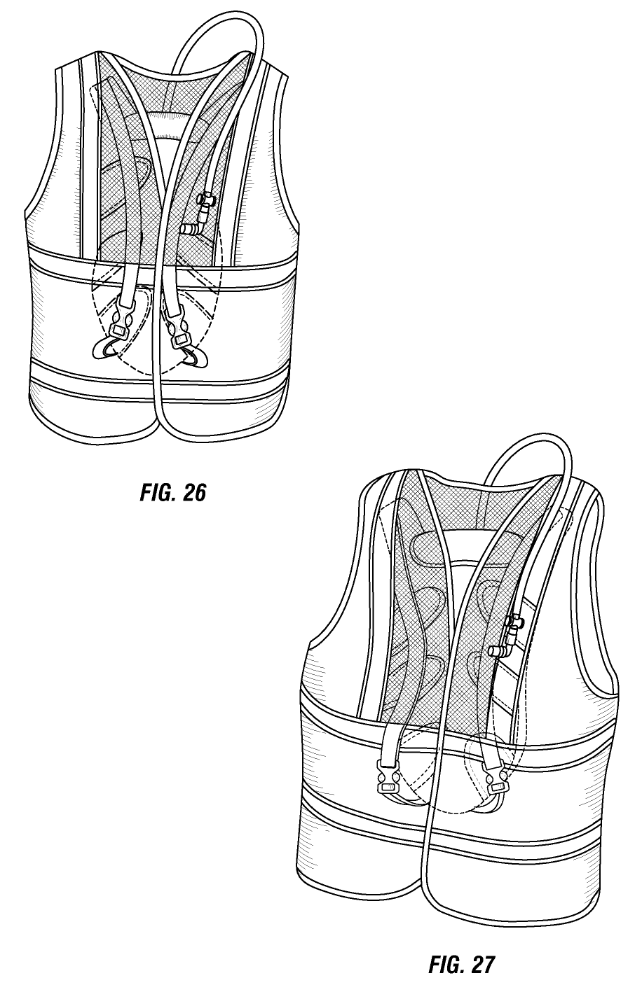

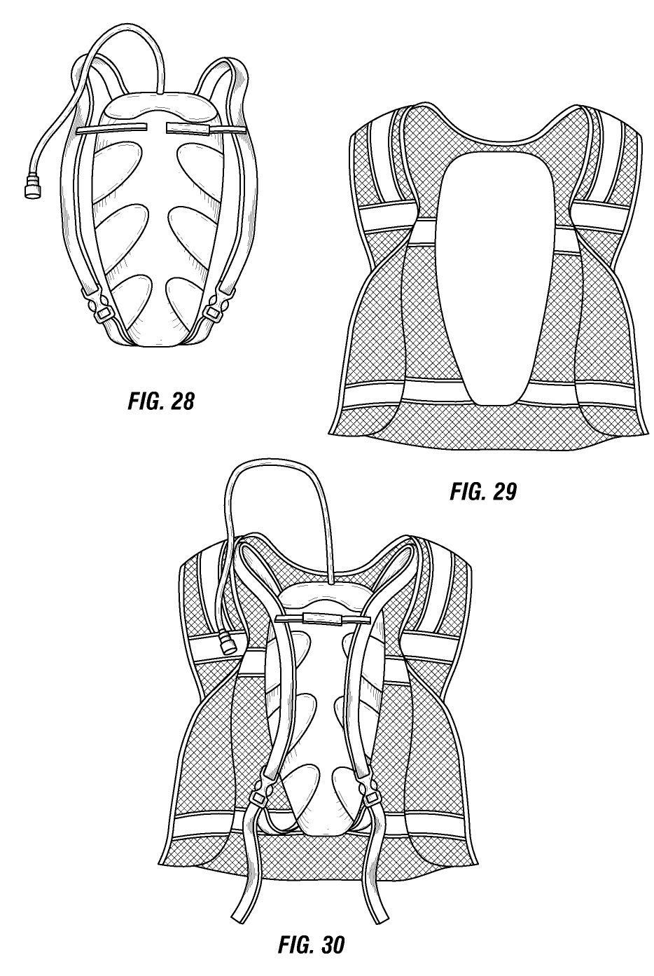

FIGS. 15-30 provide illustrations of additional views, features, and alternative embodiments of the combination high visibility safety vest and hydration bladder system. The teachings provided by these illustrations are exemplary and can be replicated by a person of ordinary skill in the art without further description based on the detailed description of other embodiments provided hereinabove.

While the invention is susceptible to various modifications and alternative embodiments, exemplary embodiments have been shown by way of example in the figures and have been described herein. However, it should be understood that the invention is not intended to be limited to the exemplary embodiments disclosed. Rather, the intention is to cover all modifications, equivalents, and alternatives falling within the spirit and scope of the invention as described.

We claim:

1. A safety garment comprising:
a front section and a rear section forming a torso encircling garment; and
a hydration system, wherein the hydration system comprises:
a fluid reservoir configured to store fluid; and
a flexible tube assembly coupled to the reservoir and adapted to receive fluid from the reservoir.

2. The safety garment of claim 1, wherein the garment consists of one of a vest, a short-sleeved shirt, a long-sleeved shirt, overalls, and a jumpsuit.

3. The safety garment of claim 1, wherein the garment comprises a background material and a retroreflective material.

4. The safety garment of claim 3, wherein the background material comprises a woven material and a plurality of mesh swatches and further wherein the background material comprises a greater percentage of an exterior surface area of the safety garment than the retroreflective material.

5. The safety garment of claim 1, wherein the garment further comprises a hydration pouch capable of receiving the fluid reservoir therein.

6. The safety garment of claim 5, wherein the hydration pouch further comprises a first side and a second side, wherein the first side is directed towards a body of a user and comprises at least one insert positioned along the first side of the pouch, said insert raising at least a portion of the first side of the pouch away from the body of the user.

7. The safety garment of claim 6, wherein a plurality of inserts are positioned on the first side of the hydration pouch to create a plurality of raised channels between each of the inserts to allow for increased airflow between the hydration pouch and the body of the user.

8. The garment of claim 5, wherein the hydration pouch further comprises:
a first attachment strap having a first end and a second end, the first end of the first attachment strap coupled to the pouch;
a second attachment strap having a first end and a second end, the first end of the second attachment strap coupled to the pouch, wherein the second end of the first attachment strap and the second end of the second attachment strap are capable of being releasably coupled to one another;
a third attachment strap having a first end and a second end, the first end of the third attachment strap coupled to the pouch; and
a fourth attachment strap having a first end and a second end, the first end of the fourth attachment strap coupled to the pouch, wherein the second end of the third attachment strap and the second end of the fourth attachment strap are capable of being releasably coupled to one another.

9. The safety garment of claim 5, wherein the rear section of the garment comprises an interior portion and an exterior portion and wherein the hydration pouch is substantially positioned along the interior portion of the rear section of the safety garment.

10. The safety garment of claim 1, wherein the hydration system further comprises a mouthpiece fluidicly coupled to the flexible tube assembly.

11. The safety garment of claim 1, wherein the mouthpiece is a bite-actuated mouthpiece.

12. The safety garment of claim 1, wherein the hydration system further comprises a flow-restricting device comprising:
a body having an input mount, an output mount and a fluid passageway extending therebetween, wherein the input mount is configured to be coupled to the flexible tube assembly to receive fluid therefrom; and
a flow-restricting mechanism adapted to be selectively positionable between at least an open configuration, where fluid may flow through the flow-restricting device, and a closed configuration, where fluid cannot flow through the flow-restricting device.

13. The safety garment of claim 12, wherein the output mount is coupled to a mouthpiece.

14. The safety garment of claim 1, wherein the fluid reservoir comprises a bladder further comprising an input port and an exit port, wherein the exit port is fluidicly coupled to the flexible tube assembly.

15. A safety vest comprising:
a substantially vest-shaped garment comprising:
a background material, wherein at least a portion of the background material comprises a mesh material; and
a retroreflective material, wherein the background material comprises a greater percentage of an exterior surface area of the vest;
a hydration system positioned adjacent the vest, the hydration system comprising:
a bladder configured to store fluid, the bladder comprising an exit port;
a flexible tube assembly comprising a first end and a second end, said first end in fluid communication with the exit port;
a flow-restricting device comprising:
a body comprising an input mount, an output mount, and a fluid passageway extending therebetween, said input mount in fluid communication with the second end of the flexible tube assembly; and
a flow-restricting mechanism capable of being positioned within the fluid passageway and adapted to be selectively positionable between at least an open configuration, where fluid may flow through the flow-restricting device, and a closed configuration, where fluid substantially cannot flow through the flow-restricting device; and
a mouthpiece in fluid communication with the output mount of the flow-restricting device.

16. The safety vest of claim 15, wherein the vest-shaped garment further comprises a hydration pouch capable of receiving the bladder therein, wherein the bladder is positioned within the pouch.

17. The safety vest of claim 16, wherein the pouch further comprises a first side and a second side, wherein the first side is substantially positioned adjacent a body of a user, the first side comprising a plurality of risers positioned along a surface of the first side of the pouch for raising a portion of the first side of the pouch away from the body of the user.

18. The safety vest of claim 15, wherein the flow-restricting mechanism is biased in the closed position.

19. A safety garment comprising:
a front section and a rear section forming a torso encircling garment;
a first shoulder strap and a second shoulder strap, each strap having a first end and a second end, wherein the first end of each strap is coupled to the rear section of the garment; and
a hydration system releasably coupled to the garment, wherein the hydration system comprises:
a fluid reservoir configured to store fluid;
a flexible tube assembly in fluid communication with the reservoir and adapted to receive fluid from the reservoir; and
a flow restricting device in fluid communication with the flexible tube assembly.

20. The garment of claim 19, wherein the flow restricting device comprises a mouthpiece.

21. The garment of claim 19, wherein the hydration system further comprises a mouthpiece.

22. The garment of claim 19, further comprising a hydration pouch capable of receiving the fluid reservoir therein, wherein the bladder is removably positioned within the hydration pouch, the hydration pouch further comprising:
a first attachment strap having a first end and a second end, the first end of the first attachment strap coupled to the pouch, wherein at least a portion of the first attachment strap is positioned adjacent the first shoulder strap;
a second attachment strap having a first end and a second end, the first end of the second attachment strap coupled to the pouch, wherein the second end of the first attachment strap and the second end of the second attachment strap are capable of being releasably coupled to one another;
a third attachment strap having a first end and a second end, the first end of the third attachment strap coupled to the pouch, wherein at least a portion of the third attachment strap is positioned adjacent the second shoulder strap; and
a fourth attachment strap having a first end and a second end, the first end of the fourth attachment strap coupled to the pouch, wherein the second end of the third attachment strap and the second end of the fourth attachment strap are capable of being releasably coupled to one another.

23. The garment of claim 19, further comprising a hydration pouch capable of receiving the fluid reservoir therein, wherein the bladder is removably positioned within the hydration pouch, the hydration pouch further comprising:
a first attachment strap having a first end and a second end, the first end of the first attachment strap is coupled to the pouch and the second end of the first attachment strap is coupled to the pouch and wherein at least a portion of the first attachment strap is positioned adjacent the first shoulder strap; and
a second attachment strap having a first end and a second end, the first end of the second attachment strap is coupled to the pouch and the second end of the second attachment strap is coupled to the pouch and wherein at least a portion of the second attachment strap is positioned adjacent the second shoulder strap.

24. The garment of claim 23, wherein the first attachment strap further comprises a first adjustment mechanism for adjusting the length of the first attachment strap and the second attachment strap further comprises a second adjustment mechanism for adjusting the length of the second attachment strap.

25. The garment of claim 19, wherein the garment comprises a background material and a retroreflective material.
